(19) United States
(12) Patent Application Publication
(10) Pub. No.: US 2010/0281113 A1
(43) Pub. Date: Nov. 4, 2010

(54) METHOD AND APPARATUS FOR AUTOMATICALLY MATCHING CONTACTS

(75) Inventors: Hans Markus Laine, Oulu (FI); Hannu Antero Simonen, Oulu (FI)

Correspondence Address: DITTHAVONG MORI & STEINER, P.C., 918 Prince Street, Alexandria, VA, 22314, US

(73) Assignee: Nokia Corporation, Espoo (FI)

(21) Appl. No.: 12/432,266

(22) Filed: Apr. 29, 2009

(51) Int. Cl. G06F 15/16

(52) U.S. Cl. 709/204; 709/201; 709/223

(57) ABSTRACT

An approach is provided for automatically matching contacts between a contact list and a members list of a social networking service. A contact matching platform retrieves one or more entries from a contact list and one or more entries from a members list of a social networking service. The platform then automatically determines matches between the entries from the contact list and the entries from the members list according to predetermined criteria.

### BACKGROUND

Wireless (e.g., cellular) service providers and device manufacturers are continually challenged to deliver value and convenience to consumers by, for example, providing compelling network services. One area of interest has been in the management of personal information, given the ever growing services (e.g., social networking services) and communication means. However, as the use and variety of services and personal information management applications increase, the user faces the burden of managing a growing number of contact lists and members lists associated with each service.

### Some Example Embodiments

Therefore, there is a need for an approach for efficiently and conveniently managing multiple contact lists and members lists.

According to one embodiment, a method comprises retrieving one or more entries from a contact list. The method also comprises retrieving one or more entries from a members list of a social networking service. The method further comprises automatically matching the one or more entries of the contact list with one or more respective entries of the members list according to predetermined criteria.

According to another embodiment, an apparatus comprising at least one processor, and at least one memory including computer program code, the at least one memory and the computer program code configured to, with the at least one processor, cause the apparatus to retrieve one or more entries from a contact list. The apparatus is also caused to retrieve one or more entries from a members list of a social networking service. The apparatus is further caused to automatically match the one or more entries of the contact list with one or more respective entries of the members list according to predetermined criteria.

According to another embodiment, a computer-readable storage medium carrying one or more sequences of one or more instructions which, when executed by one or more processors, cause an apparatus to retrieve one or more entries from a contact list. The apparatus is also caused to retrieve one or more entries from a members list of a social networking service. The apparatus is further caused to automatically match the one or more entries of the contact list with one or more respective entries of the members list according to predetermined criteria.

According yet to another embodiment, an apparatus comprises means for retrieving one or more entries from a contact list. The apparatus also comprises means for retrieving one or more entries from a members list of a social networking service. The apparatus further comprises means for automatically matching the one or more entries of the contact list with one or more respective entries of the members list according to predetermined criteria

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of automatically matching contacts, according to one embodiment;

FIG. 2 is a diagram of the components of a contact matching platform, according to one embodiment;

FIG. 3 is a diagram of the data structure of a contact list and the data structure of a members list utilized in the system of FIG. 1, according to one embodiment;

FIG. 4 is a flowchart of a process for automatically matching contacts, according to one embodiment;

FIG. 5 is a flowchart of a process for browsing a contact list using automatic contact matching, according to one embodiment;

FIGS. 6A-6D are diagrams of user interfaces utilized in the processes of FIGS. 4 and 5, according to various embodiments;

FIG. 7 is a diagram of hardware that can be used to implement an embodiment of the invention;

FIG. 8 is a diagram of a chip set that can be used to implement an embodiment of the invention; and

FIG. 9 is a diagram of a mobile station (e.g., handset) that can be used to implement an embodiment of the invention.

### DESCRIPTION OF PREFERRED EMBODIMENT

A method and apparatus for automatically matching contacts are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although various embodiments are described with respect to automatically matching a entries from a contact list contained in a mobile device against a members list of a social networking service, it is contemplated that the approach described herein may be used to automatically match a contact list stored on any type of communication device (e.g., desktop computer, laptop computer, Internet nodes, communicators, personal digital assistants, etc.) or web service (e.g., a personal information management web service). As used herein, the term “contact list” includes, for instance, a directory of names and related information (e.g., telephone number, E-mail address, location, hobbies, interests, characteristics, etc.) contained in a mobile device, a web service, another social networking service, and/or the like.

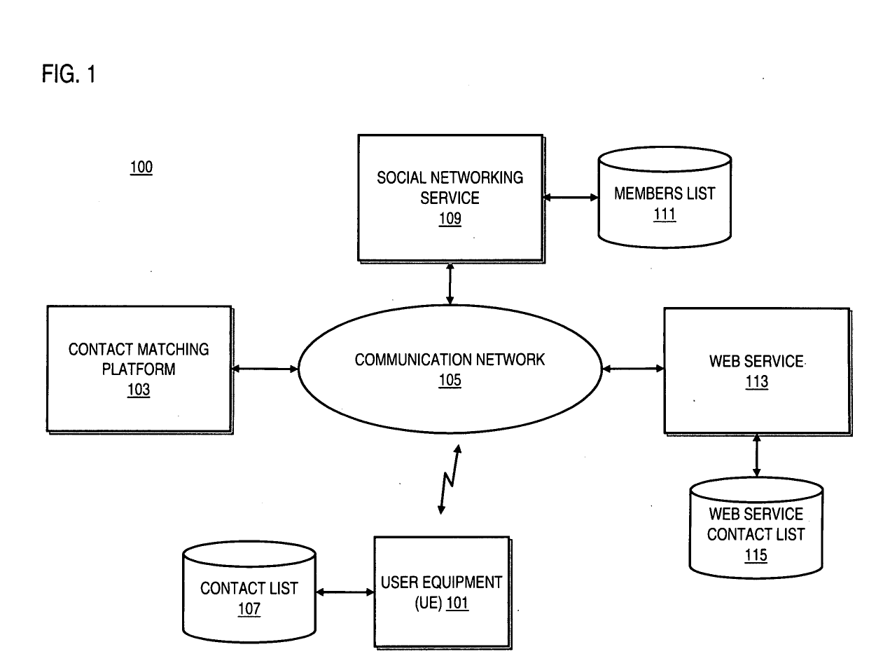

FIG. 1 is a diagram of a system capable of automatically matching contacts, according to one embodiment. As the use of multiple social networking services becomes increasingly popular, users are discovering that their contacts are also becoming increasingly spread across multiple services, applications, and devices. In a typical case, a user may have multiple sets of contacts (e.g., friends) stored in any number of places, such as (1) a first social networking service (e.g., MySpace®), (2) a second social networking service (e.g., Facebook®), (3) a personal information management web service (e.g., Ovi®), (4) the user's mobile device, and (5) an E-mail application running on the user's personal computer. Traditionally, each service or application manages its respective set of contacts independently. The independence of the various contact lists can, in turn, add a significant amount of complexity to the process of establishing relationships within a social networking service when trying to link contacts between multiple services (e.g., when inviting a contact included in a contact list on the user's mobile device to join a social networking service). For example, a user would like to invite friends stored as contacts in the user's mobile device to join the user's social networking group in a social networking service. The user typically would have to either manually import the contact list from the mobile device into the social networking service and then search for the each contact in the social networking service, or manually search for each contact in the members list of the social networking service before inviting the contact to join the social networking group. If the manual import or search is incomplete or not performed properly, the user may have to make unnecessary duplicate entries in either the contact list or the social networking service.

To address this problem, a system 100 of FIG. 1 bypasses the both the manual import and manual search processes by enabling automatic matching of one or more entries from the contact list against respective entries from the members list of a social networking service. The matched entries between the contact list and the members list can then be linked to avoid duplicate entries and to facilitate invitation of the user's friends in the contact list to join one or more groups in the social networking service. More specifically, the system 100 automatically and directly retrieves information (e.g., name, phone number, E-mail address, etc.) from a contact list to determine whether they match any respective entries in a members list of a social networking service. The system 100 also enables matching in the opposite direction (e.g., retrieving information from the members list of a social networking service for matching against the entries of a contact list). The automatic matching is initiated, for instance, when the user invites a friend to join a social networking group, receives an invitation to join a social networking group, adds a friend to a social networking group, or browses a contact list. The system 100, therefore, advantageously reduces the complexity and number of steps to invite contacts from a contact list to join a group in a social networking service.

As shown in FIG. 1, the system 100 comprises a user equipment (UE) 101 having connectivity to a contact matching platform 103 via a communication network 105. The UE 101 is any type of mobile terminal, fixed terminal, or portable terminal including a mobile handset, station, unit, device, multimedia tablet, Internet node, communicator, desktop computer, laptop computer, Personal Digital Assistants (PDAs), or any combination thereof. It is also contemplated that the UE 101 can support any type of interface to the user (such as “wearable” circuitry, etc.). In exemplary embodiments, the UE 101 has connectivity to a database 107 of one or more contact lists. The contact list database 107 may include, for instance, any number of fields, including, for example, name of contact, telephone number, E-mail address, and other related information fields. Moreover, the contact list may be associated with the UE 101 itself or with one or more applications running on the UE 101.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), the Internet, or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, mobile ad-hoc network (MANET), and the like.

The UE 101 also has connectivity to a social networking service 109 through the communication network 105. In one embodiment, the social networking service 109 may be provided by either the operator of the communication network 105 or a third party (not shown). By way of example, the social networking service 109 enables users to form online communities for sharing common interests (e.g., hobbies, work, family, organizations, etc.). A user of the social networking service 109 can use the service 109 to, for instance, form relationships with other members of the service. Historically, there have been a variety of social networking services 109 available to users (e.g., MySpace®, Facebook®, LinkedIn®, etc.) catering to various interests. Accordingly, it is not uncommon for users to belong to multiple social networking services 109. The social networking service 109 includes, at least in part, a database 111 of one or more members lists associated with the social networking service 109. The members list database 111 stores, for instance, a list of registered members of the service 109.

As shown in FIG. 1, the UE 101 further has connectivity to a web service 113 via communication network 105. In various embodiments, the web service 113 enables the UE 101 to synchronize an existing contact list (e.g., the contact list database 107) or create a new contact list in the web service contact list database 115. For example, the web service 113 may provide for online personal information management (e.g., Google®, Yahoo®) including management of user contacts. It is contemplated that the web service 113 may be any service including at least in part a contact list. In addition, through connectivity to the communication network 105, the contact matching platform 103 also has connectivity to the social networking service 109 and the web service 113.

In this way, the contact matching platform 103 has access to contact list database 107 of the UE 101, the members list database 111 of the social networking service 109, and the web service contact list database 115 of the web service 113 to enable automatic matching of contacts. It is contemplated that the communication network 105 may include multiple social networking services 109 or web services 113. Moreover, the contact matching platform 103 may be implemented as a stand-alone service on the network side of the communication network 105 (as shown in FIG. 1). In addition or alternatively, the contact matching platform may be implemented in the UE 101, the social networking service 109, and/or the web service 113.

By way of example, the UE 101, the contact matching platform 103, the social networking service 109, and the web service 113 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

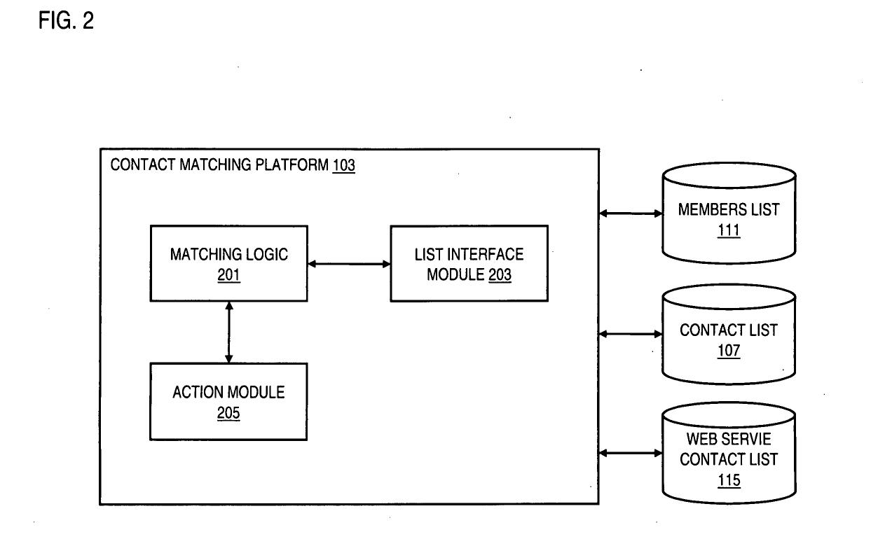

FIG. 2 is a diagram of the components of a contact matching platform 103, according to one embodiment. By way of example, the contact matching platform 103 includes one or more components for automatically matching one or more entries from a contact list (e.g., contact list database 107) with respective entries from the members list database 111 of the social networking service 109. It is contemplated that the functions of these components may be combined in one or more components or performed by other components of equivalent functionality. As shown in FIG. 2 and as described with respect to FIG. 1, the contact matching platform 103 interacts with the members list database 111, the contact list database 107, the web service contact list database 115, or a combination thereof to perform its matching functions. In this embodiment, the contact matching platform 103 includes a matching logic 201 for automatically determining whether one or more entries of the contact list database 107 or the web service contact list database 115 match respective entries from the members list database 111 according to predetermined criteria. The predetermined criteria, for example, include name, phone number, E-mail address, and location. In certain embodiments, the predetermined criteria may also include more descriptive parameters such as hobbies, interests, characteristics of the contacts as defined in, for instance, the social networking service 109 or the web service 113. The matching logic 107 interacts with a list interface module 203 to retrieve information corresponding to the predetermined matching criteria from the contact list database 107, the web service contact list database 115, and/or the members list database 111.

In one embodiment, the matching logic 201 determines whether there is a complete match of all predetermined criteria between the one or more entries in the contact list (e.g., contact list database 107, web service contact list database 115) and the respective entries in the members list database 111. For example, the matching logic 201 determines a complete match if all retrieved information related to the predetermined criteria (e.g., name, phone number, E-mail) between the contact list and the members list database 111 match. In addition or alternatively, it is contemplated that the matching logic 107 can present partial matches to the user for confirmation. In one embodiment, a partial match includes matching a name based on alternate spellings (e.g., “Thomas Smith” in the contact list database 107 vs. “Tom Smith” in the members list database 111). In another embodiment, a partial match may be determined if some, but not all, of the criteria match, e.g., the matching logic may declare a partial match if the name and E-mail address match, but not the phone number. It is contemplated that matching logic 107 can use any parameter or data field included in the contact list database 107, the web service contact list database 115, and/or the members list database 111 to match two entries.

On determination of a match, the matching logic 201 can direct the action module 205 to initiate an action in, for instance, the social networking service 109, the UE 101, the web service 113, or a combination thereof based on the matching. In certain embodiments, the matching logic 201 can automatically initiate the action on determination of a match. In other embodiments or when there is a partial match, the matching logic 201 can request user confirmation of the action before proceeding. By way of example, the action may include sending a friend invitation or request to matched entries, accepting a friend invitation or request from matched entries, sharing information with matched entries, synchronizing the matched entries between the contact list (e.g., contact list database 107, web service contact list database 115) and the members list database 111.

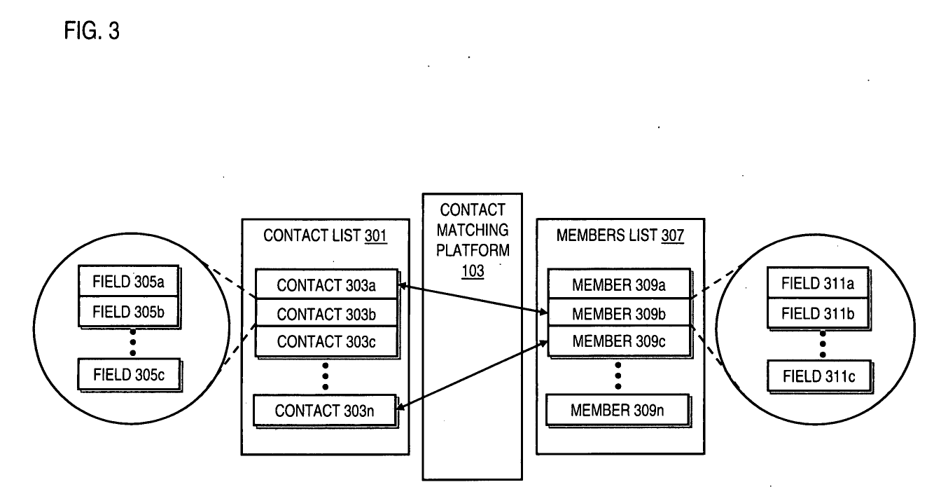

FIG. 3 is a diagram of the data structure of a contact list and the data structure of a members list utilized in the system of FIG. 1, according to one embodiment. As in typical database management systems, data can be stored in one or more data containers, each container contains records, and the data within each record is organized into one or more data fields. As shown in FIG. 3, a contact list data container 301 corresponds to, for instance, either the contact list database 107 or the web service contact list database 115. The contact list data container 301 includes contact records 303a-303n representing each entry of the contact list. Further, each contact 303 may be broken down into data fields 305a-305n correlating to various parameters that describe a contact (e.g., name, telephone number, E-mail address, hobbies, interests, characteristics). In this regard, the number of data fields 305a-305n, is dependent on the level of detail that the user or web service 113 would like to maintain. Hence, it is possible for two different contact lists to have different data fields.

Similarly, in one embodiment, the members list data container 307 corresponds to the members list database 111 of the social networking service 109. The members list data container 307 includes member records 309a-309n correlating to, for instance, each registered member of the social networking service 109. Each member record 309 is further broken down into data fields 311a-311b represent various parameters that describe the member (e.g., name, telephone number, E-mail address, hobbies, interests, characteristics). As described with respect to the contact list data container 301, the number of data fields 311 is dependent on, for instance, the level of detail that the social networking service 109 would like to maintain.

As shown in FIG. 3, the contact matching platform 103 provides the logic for matching entries in the contact list data container 301 and their respective entries in the members list data container 307. As described previously, the data fields between contact lists and members list database 111 may differ depending on the level of detail desired for the respective list. In addition, different services (e.g., the social networking service 109, web service 113, and UE 101) may name each data field differently even though they might contain the same or similar information. For example, the name field 305a in the contact list data container 301 may be called “NAME” whereas the equivalent data field in the members list data container 307 may be called “FULL NAME.” Accordingly, it is contemplated that the contact matching platform 103 includes logic to either automatically or with user input correlate fields between the contact list data container 301 and the members list data container 307 to facilitate matching.

As part of the matching process, the contact matching platform 103, for instance, compares records in the contact list data container 301 against records in the members list data container 307 to determine which if any of the records match. As described with respect to FIG. 2, the comparison includes retrieving information from the data fields 305 of the contact list data container 301 and the data fields 311 of the members list data container 307 corresponding to the predetermined criteria chosen for matching (e.g., name, telephone number, E-mail address). As shown, the contact matching platform 103 matched contact 303a with member 309b and contact 303n with member 309c.

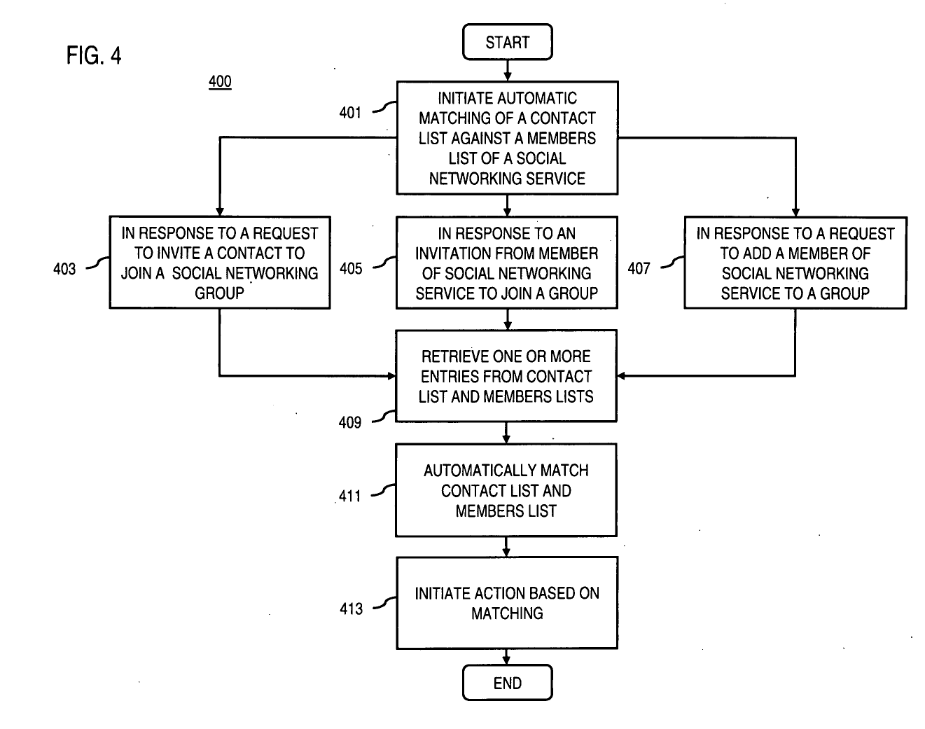

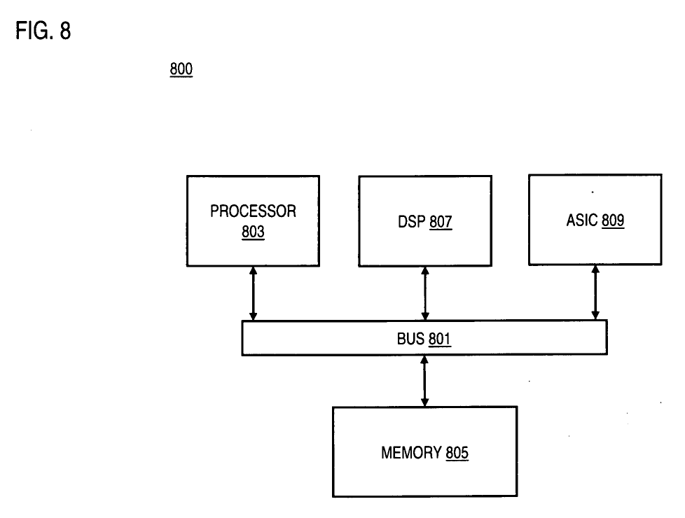

FIG. 4 is a flowchart of a process for automatically matching contacts, according to one embodiment. In one embodiment, the contact matching platform 103 performs the process 400 and is implemented in, for instance, a chip set including a processor and a memory as shown FIG. 8. In step 401, the contact matching platform 103 initiates automatic matching of a contact list (e.g., contact list database 107, web service contact list database 115) against a members list database 111 of a social networking service 109. In one example, the automatic matching is initiated in response to a request from a user of the contact list to invite one or more contacts from the contact list to join a group (e.g., the user's friends group) of the social networking service 109 (step 403). For instance, the user would like to invite a contact from a contact list stored on the user's mobile device to join the user's friends group in the social networking service 109 and sends an invitation to the contact accordingly. The sending of the invitation initiates the automatic matching to determine whether the invited contact is already a member of the social networking service 109. If the contact is already a member, the process for inviting the contact is, for instance, simplified.

In a second example, the automatic matching is initiated in response to the user of a contact list receiving an invitation from a member of the social networking service 109 to a join a group (e.g., the member's friends group) of the social networking service 109 (step 405). In various embodiments, viewing of the received invitation by the user initiates the automatic matching to determine whether the member who sent the invitation is already in the user's contact list. If the member is already in the user's contact list, the requesting member can be linked with the respective entry in the contact list.

In a third example, the automatic matching is triggered by a request from the user of a contact list to add a person who is already a member of the social networking service 109 to join a group (e.g., the user's friends group) of the social networking service 109 (step 407). For example, the user is browsing a member's profile page on the social networking service 109 and decides to click on link (e.g., a link to “Add as Friend”) to invite the member to join the user's friends group. The selection of the “Add as Friend” link initiates automatic matching to determine whether the invited member is already in the user's contact list. If the member is already in the user's contact list, the requesting member can be linked with the respective entry in the contact list.

After the automatic matching is initiated, the contact matching platform 103 automatically retrieves one or more entries from the user's contact list and one or more entries from the members list database 111 of the social networking service 109 (step 409). The retrieval occurs automatically and may be facilitated by, for instance, using an application programming interface (API) to access the functions and data of either the contact list (e.g., the contact list database 107 of the UE 101 or the web service contact list database 115 of the web service 113) or the members list database 111. In various embodiments, the information retrieved from either the contact list or the members list database 111 is dependent on the predetermined criteria used for matching. For example, if the predetermined criteria include matching name, telephone, and E-mail, these three parameters are retrieved from the respective contact list or members list database 111.

The contact matching platform 103 then automatically matches the one or more entries of the contact list with the one or more respective entries of the members list database 111 according to the predetermined criteria (step 411). For example, matching includes comparing the parameters from the contact list against the respective parameters from the members list database 111. If the parameters match for a particular contact or member, the contact matching platform 103, for instance, declares a match. As described with respect to FIG. 2, the contact matching platform may also present partial matches to the user for confirmation.

In certain embodiments, the matching of one or more contacts initiates a corresponding action in either the UE 101, the web service 113, the social networking service 109, or a combination thereof. For example, the action that is initiated in response to a match includes sending a friend request, accepting a friend request, sharing information (e.g., transmitting an update of latest activities associated with the user), sending a communication (e.g., sending an E-mail or instant message), synchronizing the contact list and the members list (e.g., to ensure that both the contact list and the members list contain the same and/or most current information), or a combination thereof. The contact matching platform 103 may also determine what action to take based on the context of the social networking service 109 or the web service that is being used. For example, if the automatic matching was triggered by sending an invitation to join a social networking service group to one contact in the contact list, the contact matching platform 103 may automatically send invitations to all other matched contacts in the contact list. In other embodiments, the action is offered to the user as a suggested action. In yet other embodiments, no automatic action is taken or suggested.

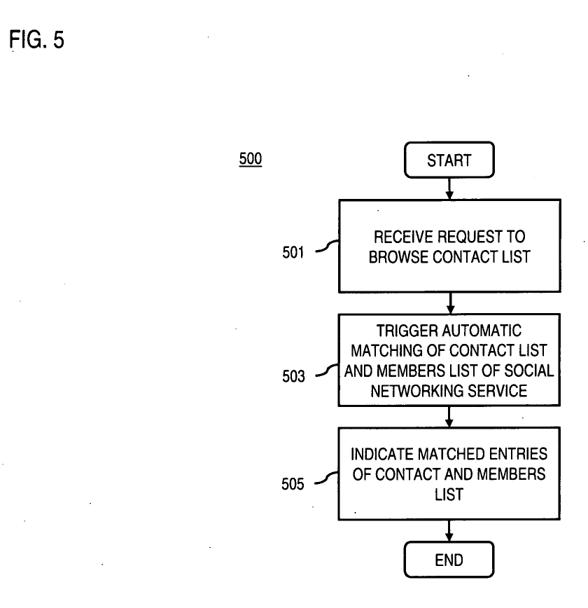

FIG. 5 is a flowchart of a process for browsing a contact list using automatic contact matching, according to one embodiment. In one embodiment, the contact matching platform 103 performs the process 500 and is implemented in, for instance, a chip set including a processor and a memory as shown FIG. 8. In this example, the contact matching platform 103 is configured to perform automatic matching during browsing of a contact list. It is contemplated that the user may configure this functionality at any time before or during browsing of the contact list. In addition, the contact matching platform 103 may be set by default to either have this feature enabled or disabled. If disabled by default, the user, for instance, activates the feature by updating the appropriate settings. It is also assumed that the user has already registered and activated the social networking service 109.

In step 501, the contact matching platform receives a request from a user to browse a contact list (e.g., contact list database 107 or web service contact list database 115). For example, this request may be initiated by displaying the contact list while the automatic matching feature for browsing is activated. As the user browses the list, the contact matching platform 103 automatically matches the browsed entries of the contact list against the members list database 111 of the social networking service 109 (step 503). The contact matching platform 103 may, for instance, match all contacts at one time and/or match only those contacts that are displayed to the user. Based on the automatic matching process, the contact matching platform 103 indicates any matched entries in the contact list (step 505). It is contemplated that the contact matching platform 103 may make this indication using any means to highlight the matched entries (e.g., highlight matched entries in a different color or type face, mark matched entries with an icon, marked matched entries with a text label, group matched entries together, audible alert when the matched entry is selected, etc).

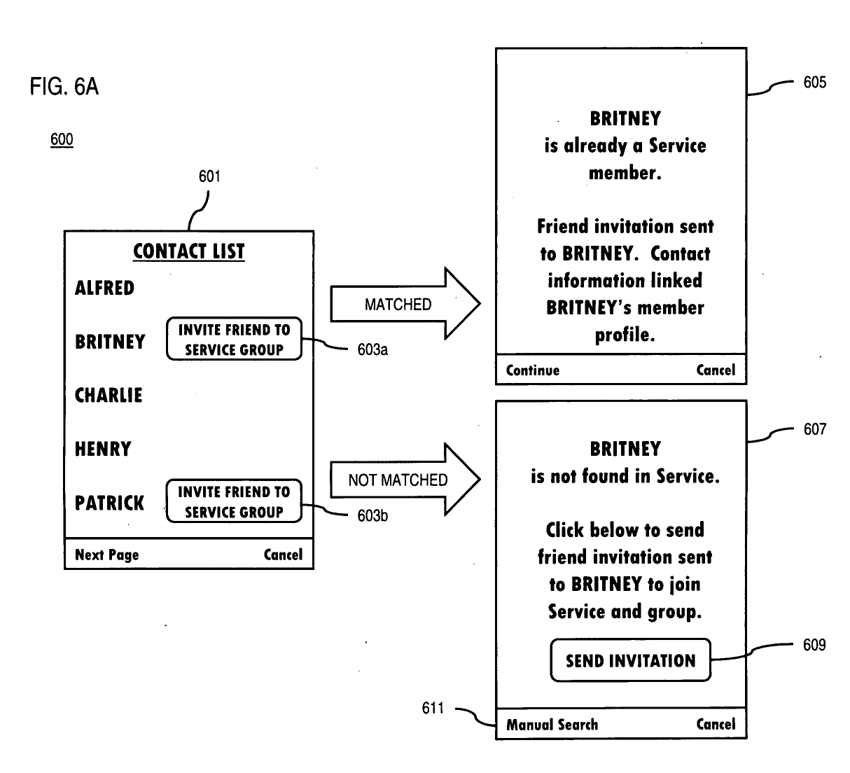

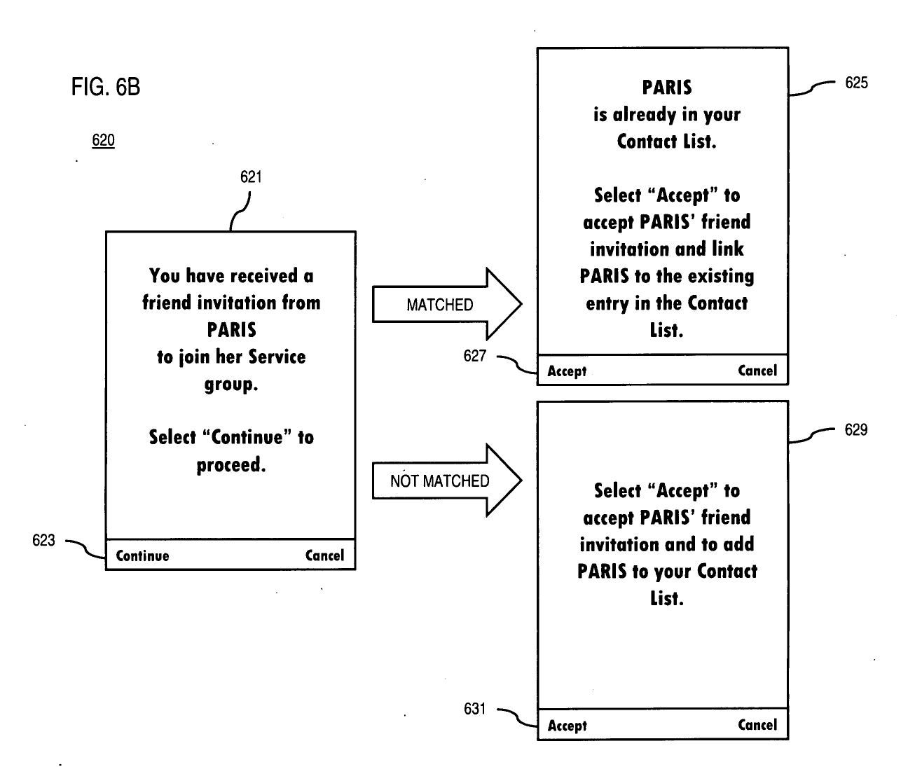

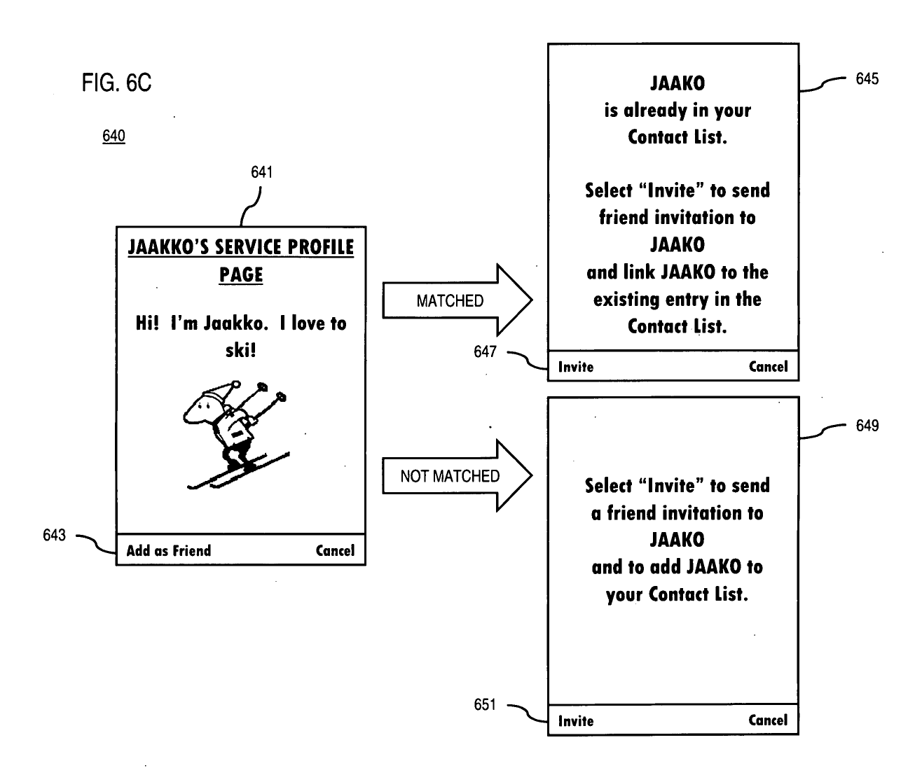

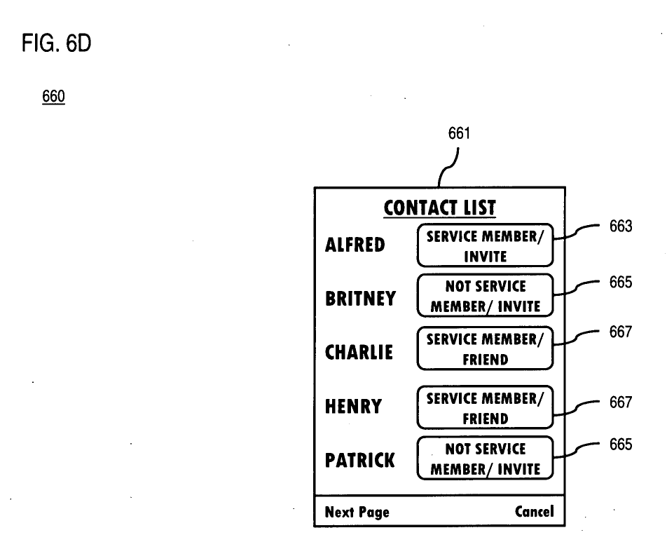

FIGS. 6A-6D are diagrams of user interfaces utilized in the processes of FIGS. 4 and 5, according to various embodiments. FIG. 6A depicts a user interface 600 for inviting a contact to join a group (e.g., the user's friends group) of a social networking service 109. In this example, the user is a registered member of the social networking service 109. As shown, a screen 601 displays a list of the user's contacts (e.g., Alfred, Britney, etc.). The screen 601 also includes a link 603 to “Invite Friend to Service Group” next to each contact that, for instance, is not currently in the user's friends group of the social networking service 109. Contacts who are already “friends” do not have the link next to their entries. In this case, Britney and Patrick are not in the user's friends group and have the links 603a-603b next to their respective contact list entries.

The user selects link 603a to invite Britney to join the user's friends group. On making the request, the contact matching platform 103 automatically performs the matching of Britney's contact entry against the members list database 111 of the social networking service 109. If the contact matching platform 103 finds a match for Britney in the members list database 111 of the social networking service 109, the screen 605 is displayed to inform the user that Britney is a member of the social networking service 109, that the invitation has been sent to Britney's member profile, and that Britney's contact information has been linked to Britney's member profile.

If the contact matching platform 103 finds no match for Britney in the members list database 111 of the social networking service 109, the screen 607 is displayed to inform the user that Britney was not found in the members list database 111. The screen provides the user with the option 609 to send the invitation anyway as well as the option 611 to perform a manual search of the members list database 111 for Britney. For example, if the user accepts the contact matching platform 103 that Britney could not be found in the members list database 111, the user can select option 609 to send the invitation. If the user believes that a manual search (e.g., using a nick name or other identifying information) of the members list database 111 might locate Britney, the user may select option 611 to perform the manual search.

FIG. 6B depicts a user interface 620 for receiving an invitation to join a group of a social networking service 109, according to one embodiment. As shown, a screen 621 alerts the user about an invitation from Paris to join a group (e.g., Paris' friends group) of the social networking service 109. Paris is a registered member of the social networking service 109. The invitation directs the user to select the option 623 to “Continue” to view more information about the invitation. On selection of the option 623 to continue, the contact matching platform 103 automatically performs the matching of Paris' member profile information against the user's contact list to determine whether Paris is already one of the user's contacts.

If the contact matching platform 103 finds a match for Paris in the user's contact list, the screen 625 is displayed informing the user that Paris is already in the user's contact list. By selection the option 627 to accept the invitation from Paris, the contact matching platform 103 automatically links Paris' member profile with her existing contact list entry. If the contact matching platform 103 finds no match for Paris in the members list database 111, the screen 629 is displayed informing the user that selecting the option 631 to accept the invitation from Paris will add Paris to the user's contact list as well as adding the user to Paris' friends group in the social networking service 109.

FIG. 6C depicts a user interface 640 for adding a member of the social networking service 109 to the user's friend group of the social networking service 109 through the member's profile page. A screen 641 depicts a profile page of Jaako, a member of the social networking service 109. The screen 641 provides a brief description of Jaako and provides an option 643 to add Jaako as a friend (e.g., add Jaako to the user's friend group). On selection of the option 643, the contact matching platform 103 automatically performs the matching of Jaako's member profile information against the user's contact list to determine whether Jaako is already one of the user's contacts.

If the contact matching platform 103 finds a match for Jaako in the user's contact list, the screen 645 is displayed informing the user that Jaako is already in the user's contact list. By selection the option 647 to invite Jaako to join the user's friends group, the contact matching platform 103 will automatically link Jaako's member profile with his existing contact list entry when Jaako accepts the invitation. If the contact matching platform 103 finds no match for Jaako in the members list database 111, the screen 649 is displayed informing the user that selecting the option 651 to invite Jaako to join the user's friends group will also add Jaako to the user's contact list when Jaako accepts the invitation.

FIG. 6D depicts a user interface 660 for performing automatic matching while browsing a contact list. In this example, the contact matching platform 103 is configured to perform automatic matching as the user browses a contact list. Screen 661 displays the user's contact list including, for instance, five entries (e.g., Alfred, Britney, Charlie, Henry, Patrick). Before displaying the contact list, the contact matching platform 103 completes its match to enable the platform 103 to display the appropriate indicators next to each contact list entry. For example, the contact matching platform 103 indicates whether each contact is a registered member of the social networking service 109. If the contact is a member, the contact matching platform 103 also indicates whether the contact is already in the user's friends group.

By way of example, the contact Alfred is a member of the social networking service 109 but is not in the user's friend group. Accordingly, the label 663 next to Alfred's contact list entry indicates that he is a service member and provides the user the option to invite Alfred to join the user's friends group. As shown, Britney and Patrick are neither service members nor members of the user's friends group. Accordingly, the labels 665 next to the entries for Britney and Patrick indicate that they are not members and provide the option to invite them to join the user's friends group. For the remaining two contact entries (i.e., Charlie and Henry), the contact matching platform 103 indicates that they are both members and are already in the user's friends group. As discussed previously with respect to FIG. 5, it is contemplated that the contact matching platform 103 may use any form of indicator (e.g., visual, audible, or combination) to indicate the matched status of each contact entry.

The processes described herein for automatically matching contacts may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

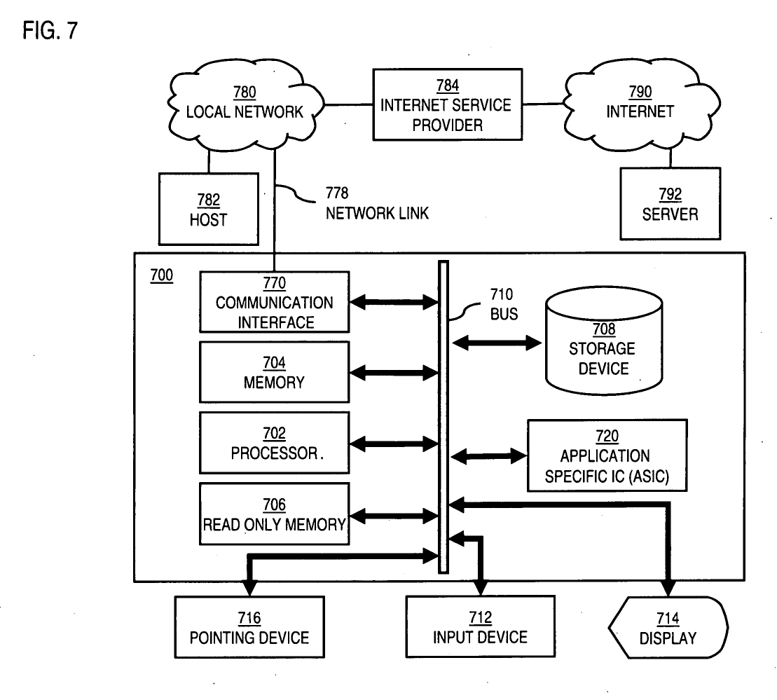

FIG. 7 illustrates a computer system 700 upon which an embodiment of the invention may be implemented. Computer system 700 is programmed to automatically match contacts as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 710 includes one or more parallel conductors of information so that information is transferred quickly among devices coupled to the bus 710. One or more processors 702 for processing information are coupled with the bus 710.

A processor 702 performs a set of operations on information related to automatically matching contacts. The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or other dynamic storage device, stores information including processor instructions for automatically matching contacts. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for automatically matching contacts, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT) or a liquid crystal display (LCD), or plasma screen or printer for presenting text or images, and a pointing device 716, such as a mouse or a trackball or cursor direction keys, or motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of application specific ICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for automatically matching contacts between the UE 101, social networking service 109, and the web service 113.

The term computer-readable medium is used herein to refer to any medium that participates in providing information to processor 702, including instructions for execution. Such a medium may take many forms, including, but not limited to, non-volatile media, volatile media and transmission media. Non-volatile media include, for example, optical or magnetic disks, such as storage device 708. Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

FIG. 8 illustrates a chip set 800 upon which an embodiment of the invention may be implemented. Chip set 800 is programmed to automatically match contacts as described herein and includes, for instance, the processor and memory components described with respect to FIG. 7 incorporated in one or more physical packages. By way of example, a physical package includes an arrangement of one or more materials, components, and/or wires on a structural assembly (e.g., a baseboard) to provide one or more characteristics such as physical strength, conservation of size, and/or limitation of electrical interaction.

In one embodiment, the chip set 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to automatically match contacts. The memory 805 also stores the data associated with or generated by the execution of the inventive steps.

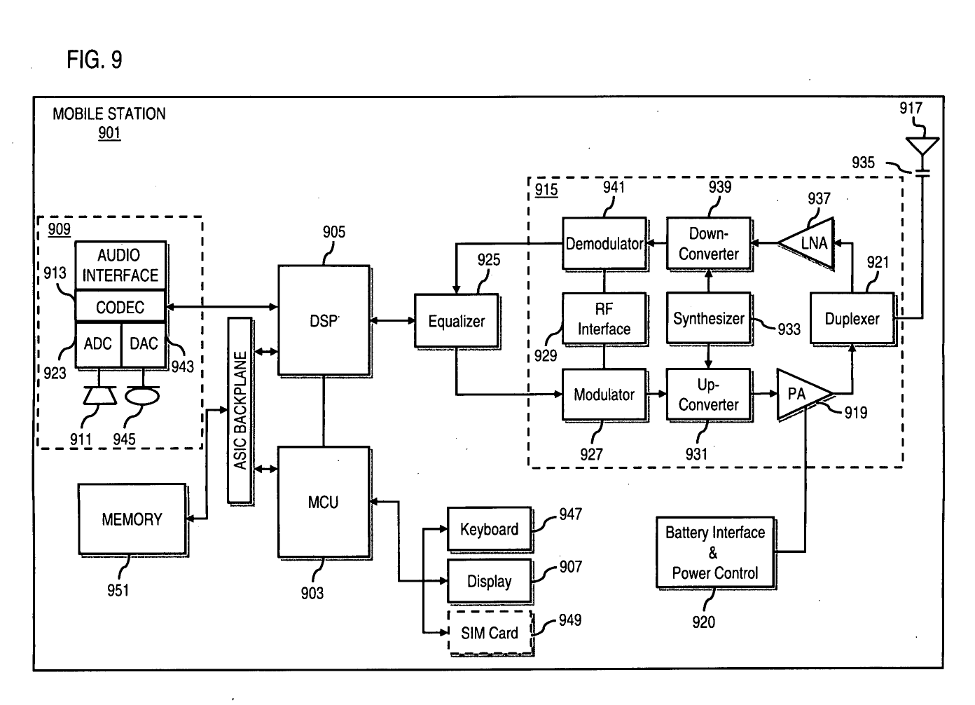

FIG. 9 is a diagram of exemplary components of a mobile station (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile station functions that offer automatic contact matching. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile station 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903—which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software facilitate user control of at least some functions of the mobile station 901 to automatically match contacts. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the station. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile station 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile station 901 on a radio network. The card 949 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
retrieving one or more entries from a contact list;
retrieving one or more entries from a members list of a social networking service; and
automatically matching the one or more entries of the contact list with one or more respective entries of the members list according to predetermined criteria.

2. A method of claim 1, wherein the contact list is associated with a mobile device, a web service, another social networking service, or a combination thereof, and wherein the predetermined criteria include name, phone number, electronic mail address, location, hobbies, interests, characteristics, or a combination thereof.

3. A method of claim 1, further comprising:
initiating an action based on the matching.

4. A method of claim 3, wherein the action comprises sending a friend request, accepting a friend request, sharing information, sending a communication, synchronizing the contact list and the members list, or a combination thereof.

5. A method of claim 1, further comprising:
initiating the automatic matching step in response to a request from a user of the contact list,
wherein the request invites one or more contacts from the contact list to join a group within the social networking service, or adds a member of the social networking service to a group within the social networking service.

6. A method of claim 1, further comprising:
initiating the automatic matching step in response to a request from a member of the social network service,
wherein the request invites a user of the contact list to join a group within the social network service.

7. A method of claim 1, further comprising:
receiving a request from a user to browse the contact list;
triggering the step of automatic matching as the user browses the list; and
indicating whether the one or more entries of the contact list are matched to one or more respective entries in the members list.

8. An apparatus comprising:
at least one processor; and
at least one memory including computer program code,
the at least one memory and the computer program code configured to, with the at least one processor, cause the apparatus to perform at least the following,
retrieve one or more entries from a contact list,
retrieve one or more entries from a members list of a social networking service, and
automatically match the one or more entries from the contact list with one or more respective entries in the members list according to predetermined criteria.

9. An apparatus of claim 8, wherein the contact list is associated with a mobile device, a web service, another social networking service, or a combination thereof, and wherein the predetermined criteria include name, phone number, electronic mail address, location, hobbies, interests, characteristics, or a combination thereof.

10. An apparatus of claim 8, wherein the apparatus is further caused to:
initiate an action based on the matching.

11. An apparatus of claim 10, wherein the action comprises sending a friend request, accepting a friend request, sharing information, sending a communication, synchronizing the contact list and the members list, or a combination thereof.

12. An apparatus of claim 8, wherein the apparatus is further caused to:
initiate the automatic matching step in response to a request from a user of the contact list,
wherein the request invites one or more contacts from the contact list to join a group within the social networking service, or adds a member of the social networking service to a group within the social networking service.

13. An apparatus of claim 8, wherein the apparatus is further caused to:
initiate the automatic matching step in response to a request from a member of the social network service,
wherein the request invites a user of the contact list to join a group within the social network service.

14. An apparatus of claim 8, wherein the apparatus is further caused to:
receive a request from a user to browse the contact list;
trigger the step of automatic matching as the user browses the list; and
indicate whether the one or more entries of the contact list are matched to one or more respective entries in the members list.

15. An apparatus of claim 8, wherein the apparatus is a mobile phone further comprising:
user interface circuitry and user interface software configured to facilitate user control of at least some functions of the mobile phone through use of a display and configured to respond to user input; and
a display and display circuitry configured to display at least a portion of a user interface of the mobile phone, the display and display circuitry configured to facilitate user control of at least some functions of the mobile phone.

16. A computer-readable storage medium carrying one or more sequences of one or more instructions which, when executed by one or more processors, cause an apparatus to perform at least the following:
retrieving one or more entries from a contact list;
retrieving one or more entries from a members list of a social networking service; and
automatically matching the one or more entries of the contact list with one or more respective entries of the members list according to predetermined criteria.

17. A computer-readable storage medium of claim 16, wherein the contact list is associated with a mobile device, a web service, another social networking service, or a combination thereof, and wherein the predetermined criteria include name, phone number, electronic mail address, location, hobbies, interests, characteristics, or a combination thereof.

18. A computer-readable storage medium of claim 16, wherein the apparatus is caused to further perform:
initiating the automatic matching step in response to a request from a user of the contact list,
wherein the request invites one or more contacts from the contact list to join a group within the social networking service, or adds a member of the social networking service to a group within the social networking service.

19. A computer-readable storage medium of claim 16, wherein the apparatus is caused to further perform:
initiating the automatic matching step in response to a request from a member of the social network service,
wherein the request invites a user of the contact list to join a group within the social network service.

20. A computer-readable storage medium of claim 16, wherein the apparatus is caused to further perform:
receiving a request from a user to browse the contact list;
triggering the step of automatic matching as the user browses the list; and
indicating whether the one or more entries of the contact list are matched to one or more respective entries in the members list.
